(19) United States
(12) Patent Application Publication
(10) Pub. No.: US 2019/0047194 A1
(43) Pub. Date: Feb. 14, 2019

(54) RESIN INJECTOR AND OIL COMPACTOR FOR LIQUID COMPOSITES MOLDING

(71) Applicants: Eduardo Antonio Julian Ruiz, Montreal (CA); Alexandre Ferreira Benevides, Laval (CA); Francois Trochu, Montreal (CA)

(72) Inventors: Eduardo Antonio Julian Ruiz, Montreal (CA); Alexandre Ferreira Benevides, Laval (CA); Francois Trochu, Montreal (CA)

(21) Appl. No.: 15/676,590

(22) Filed: Aug. 14, 2017

(51) Int. Cl. B29C 45/17; B29C 45/00; B29C 37/00; B29C 45/63

(52) U.S. Cl. CPC B29C 45/174; B29C 45/63; B29C 37/006; B29C 45/0053

(57) ABSTRACT

The present disclosure relates to a resin injector and oil compactor used to manufacture composite components by RTM and FIP processes. A resin injector comprising an automated resin degassing and charging/discharging station and an in-line heat exchanger. An oil compactor capable of applying a dynamic compaction at a desired frequency, nominal pressure and temperature to an FIP mold. A multi-injection equipment for manufacturing composite parts by RTM and FIP is provided. The multi-injection equipment includes 1 or more cylinder injectors for delivery liquid resin into an RTM or FIP mold cavity. An oil compactor equipment to work with FIP is provided. The oil compactor contains an oil container and a heat exchanger to maintain the oil at a desired temperature. The pre-heated oil is injected into the FIP under pressure after the resin injection to fulfill the impregnation of the fibrous strengthener and consolidate the composite part.

The present disclosure relates to a resin injector and oil compactor used to manufacture composite components by RTM and FIP processes. In particular, a resin injector comprising an automated resin degassing and charging/discharging station and an in-line heat exchanger. An oil compactor capable of applying a dynamic compaction at a desired frequency, nominal pressure and temperature to an FIP mold.

### BACKGROUND

In many industrial applications composite materials provide unique mechanical properties, especially high strength and stiffness in lightweight components. It is also possible to custom tailor the properties of the components via the choice of reinforcing materials, resins, layup, fiber volume fractions, and/or using specified compaction or compression loads during fabrication and/or specific manufacturing processes, etc.

In resin molding processes such as Resin Transfer Molding (RTM), a mold having an interior cavity that defines the shape of the to-be-molded component is provided. A structural reinforcement material may be placed within the mold cavity. Vacuum is pulled within the mold cavity prior to injecting the liquid resin under pressure. The resin is contained under pressure during cure to consolidate the composite material and avoid porosities within the part. In the case of Flexible Injection Process (FIP), US Patent number US20120217670A1, after resin injection, a liquid oil is injected into the counter-mold cavity to consolidate the composite part through a flexible membrane.

In RTM and Flexible Injection processes, an element is required to inject the liquid thermoset or thermoplastic resin into the mold cavity at elevated temperature, pressure and flow rate. The liquid resin injection element must be capable of controlling precisely all these three parameters. Moreover, in modern composites industry, flow rates may reach up to 20 liters per minute, temperature of 220 Celsius and pressures above 10 Bars.

Cylinder injectors are used in industry to achieve liquid resin injection in RTM. These consist of a closed cylinder charged with liquid resin, with a displacement piston sealed for vacuum and pressure leaks. The piston is connected to an electric actuator that push the piston in and out the cylinder. The liquid resin is loaded manually into the cylinder injector and then heated to the injection temperature by heating the metallic cylinder, usually by electrical heating. These cylinder injectors are very precise in displacement, which makes them very accurate on resin volume and flow rate. This is acceptable for low volume production of composite parts, however for higher volume production it is required to automate the loading of the resin.

In many RTM processes, the liquid resin has to enter the RTM mold at high temperature, much higher than the temperature at the injector. This is commonly carried out using reusable electrical heat exchangers that can be cleaned up after resin injection. This is very useful for low volume productions allowing the cleaning time required for the reusable electrical heat exchangers. However, at high volume productions these reusable electrical heat exchangers are costly and very time consuming.

### SUMMARY

According to a first aspect, a multi-injection equipment for manufacturing composite parts by RTM and FIP is provided. The multi-injection equipment include 1 or more cylinder injectors for delivery liquid resin into an RTM or FIP mold cavity. The cylinder injector contains an automated degassing and resin loading station. The cylinder injector contains also a liquid heat exchanger to quickly heat the resin during injection from the cylinder temperature up to the required injection temperature (i.e. typically 140 to 160 Celsius).

According to another aspect, an oil compactor equipment to work with FIP is provided. The oil compactor contains an oil container and a heat exchanger to maintain the oil at a desired temperature, typically between 100 and 180 Celsius. An electric pump is used to recirculate the oil between the oil container and the heat exchanger and the FIP mold. The pre-heated oil is injected into the FIP under pressure after the resin injection to fulfill the impregnation of the fibrous strengthener and consolidate the composite part. The oil compactor contains a high frequency valve allowing varying the oil pressure from a nominal value down to zero at a repeated frequency typically between 1 and 50 Hz. This repeated pressure variation generates a dynamic compaction of the fibrous strengthener in the FIP and helps consolidate the composite part.

The following general description and details are given as examples of the invention, but this is not restrictive.

### DESCRIPTION OF DRAWINGS

The accompanying drawings constitute part of this specification and illustrate several embodiments of the invention. Together with the following description, the purpose of these illustrations is to explain the principles of the disclosed apparatus and method.

FIG. 1 shows a typical configuration for molding composite components with RTM process.

FIG. 2 shows schematics of the cylinder injector containing the liquid heat exchanger.

FIG. 3 shows schematics of the cylinder injector containing the automated resin degassing and loading station.

FIG. 4 displays schematics of the automated resin degassing and loading station.

FIG. 5 shows a typical configuration for molding composite components with FIP.

FIG. 6 shows a typical configuration of the oil compactor for FIP.

FIG. 7 shows a typical molding cycle of FIP using the dynamic compactor equipment.

### DETAILED DESCRIPTION

Aspects of the apparatus and method presented herein are described in the context of a composite molding process. However, the invention is not limited to composite molding (unless such limitation is mentioned explicitly).

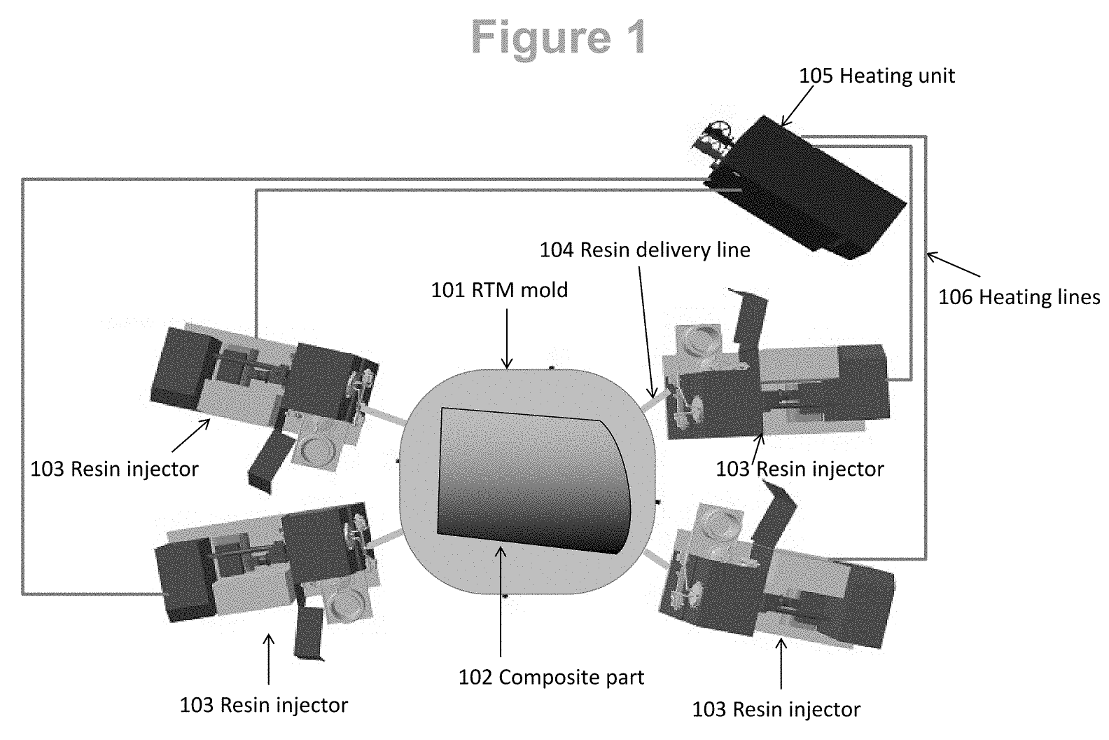

In reference to FIG. 1 an RTM mold 101 is shown, providing the geometry of the composite component to be molded. A composite component 102 is placed on the surface of the rigid RTM mold. The composite component can be made of a prepreg material or dry reinforcing fibers, i.e., typically glass, carbon or kevlar fibers. In the case of dry reinforcing fibers, a liquid resin is infused to impregnate the dry fibers. A series of resin injectors 103 is connected to the RTM mold 101 through the resin delivery lines 104 connected to the injection gates in the RTM mold (not shown). A central liquid heating device 105 is connected to each resin injector 103 through a series of heating lines 106. The central heating device 105 typically use recirculating water or oil and an internal electrical heat exchanger to heat the liquid to a desired temperature, typically between 80 and 140 Celsius. The cylindrical resin injectors 103 are interconnected with an automation device (not shown) allowing a parallel injection of the liquid resin into the RTM mold.

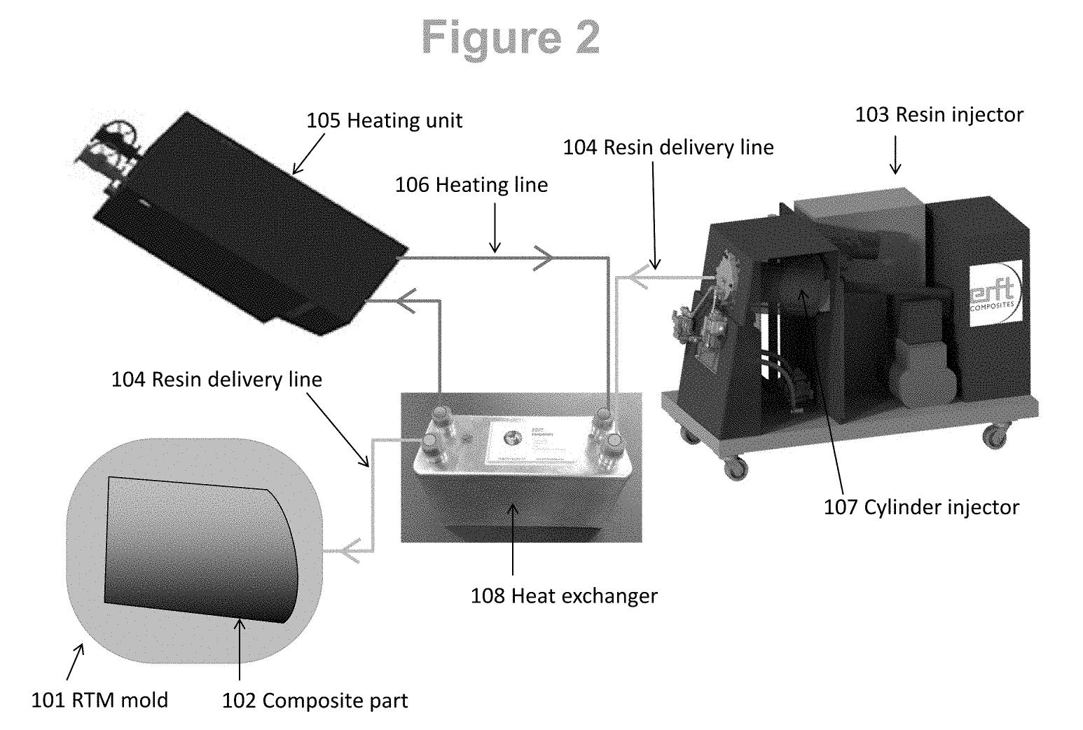

FIG. 2 shows a resin injectors 103 containing a cylinder injector 107 connected to a liquid heat exchanger 108 through the resin delivery line 104. The central liquid heating device 105 is also connected to the liquid heat exchanger 108 through the heating lines 106. The resin in the cylinder injector 107 is preheated at temperatures typically below 110 Celsius and then injected into the RTM mold 101. During resin injection, the liquid heat exchanger 108 is maintained at higher temperature, for example 180 Celsius, which increases the temperature of the liquid resin between 140 and 160 Celsius depending on flow rate. The liquid heat exchanger 108 consists typically of a parallel plates type of heat exchanger that can be reusable or disposable. Typical flow rates that can be achieved with this resin injector vary from 0.2 to 20 liter per minutes and temperatures up to 200 Celsius.

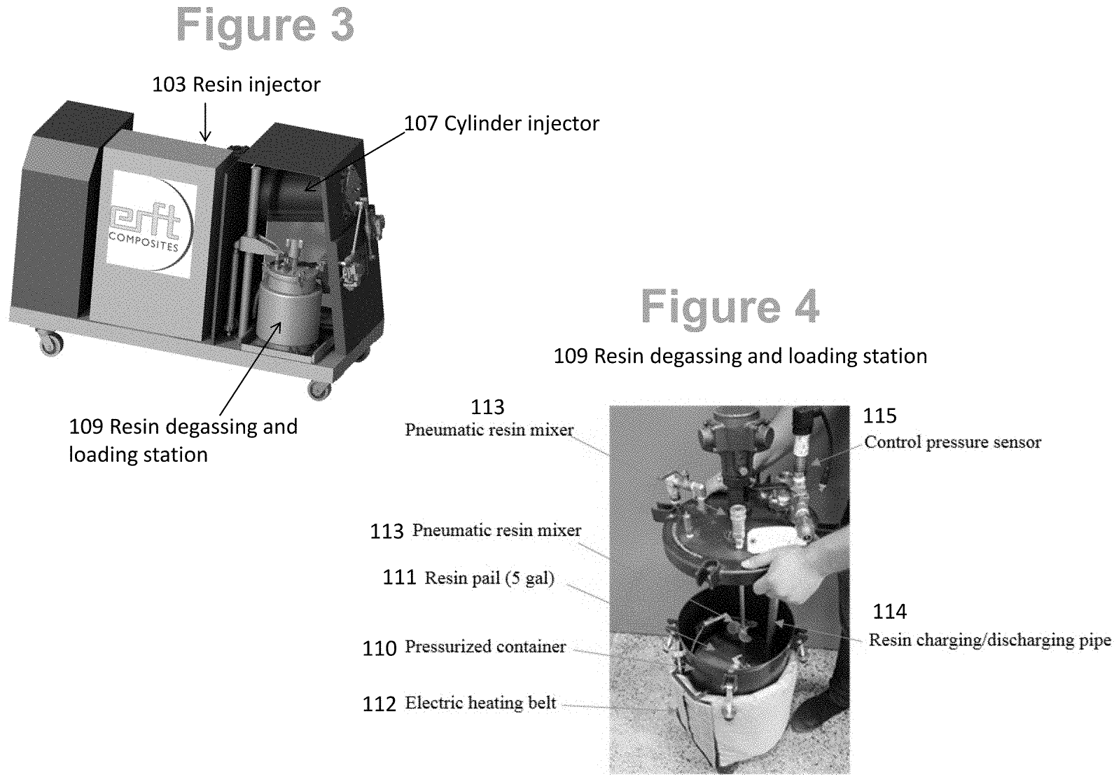

FIG. 3 shows a resin injectors 103 containing a resin degassing and loading station 109. The resin degassing and loading tasks are automated and require no human intervention.

FIG. 4 shows a resin degassing and loading station 109 containing a pressurized resin container 110. An open resin pail 111, typically 5 Gallons, is placed inside the pressurized container 110 and the cover of pressurized container is closed by hand. The pressurized container is heated at a desired temperature, typically between 60 and 100 Celsius, with an electric heating belt 112. During heating, a pneumatic resin mixer 113 is used to agitate the resin and help equilibrate the temperature. A vacuum port (not shown) is provided to the pressurized container cover to pull vacuum inside the container. Vacuum is pulled in the resin container during heating to degas the resin. Once the resin reaches the desired temperature and degassing time, it is loaded into the cylinder injector 107 through the resin charging/discharging pipe 114. To load the degassed resin into the cylinder injector automatically, the resin container 110 is pressurized typically at 3 Bars and the piston in the cylinder injector 107 is displaced out of the cylinder in such a way that the liquid resin enters to the cylinder. This is carried out automatically by a series of electrical valves that control the opening and closing of the connecting lines (not shown). A pressure sensor 115 is used to control the degassing step and resin delivery to the injector. After resin injection into the RTM mold, the residual resin in the cylinder injector 107 is poured again into the resin pail 111 inside the resin container 110. In this way, the cylinder injector is mostly clean of resin requiring minimum maintenance prior to the next injection.

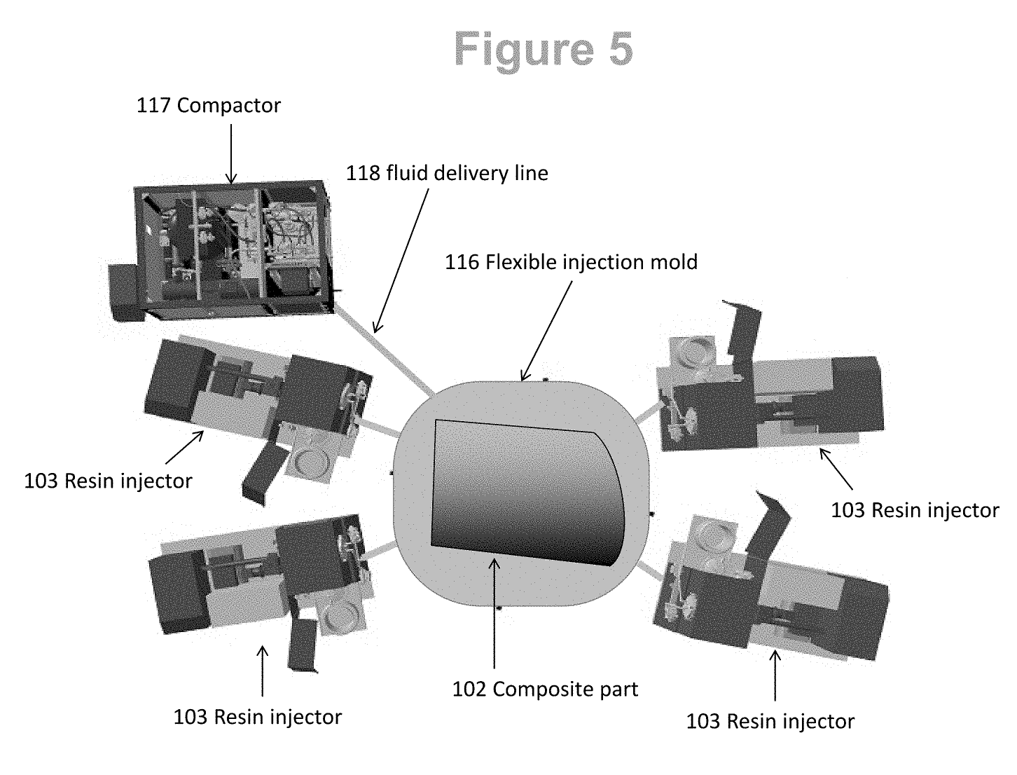

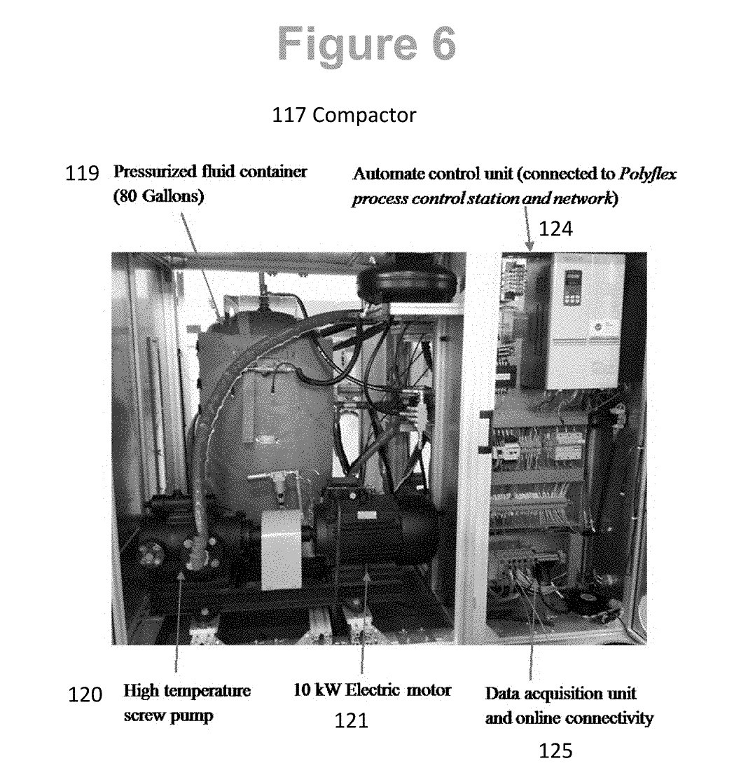

In reference to FIG. 5 a FIP mold 116 is shown, providing the geometry of the composite component to be molded. A composite component 102 is placed on the surface of the rigid FIP mold. A series of resin injectors 103 is connected to the FIP mold 116 as described in FIG. 1. A compactor 117 is connected to the FIP mold 116 through a fluid delivery line 118. The compactor 117 provides a liquid, typically oil, at a given temperature, pressure and flow rate to the FIP mold.

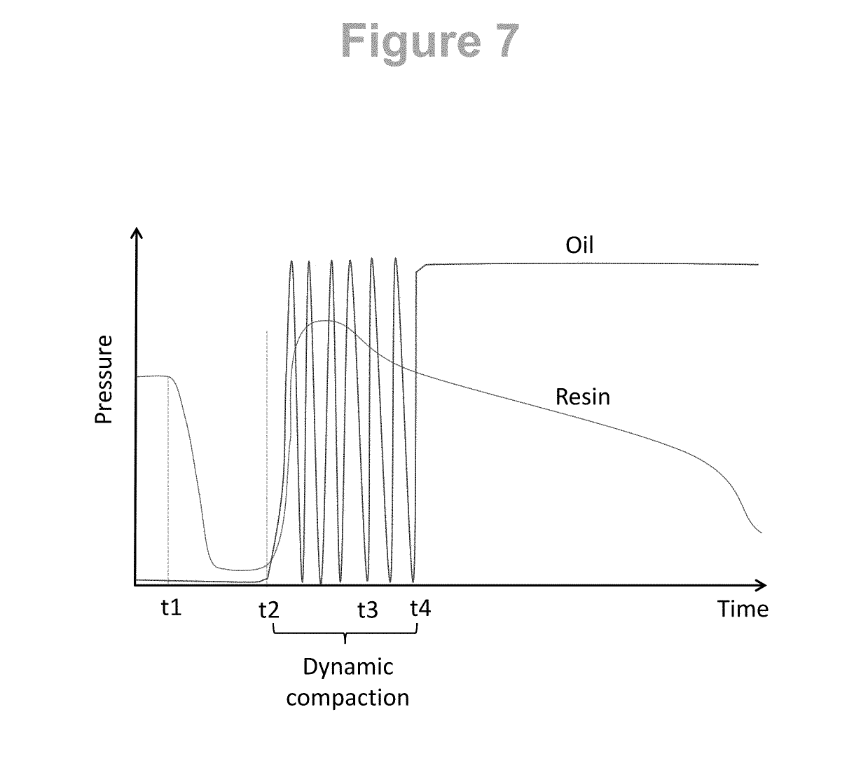

FIG. 6 shows the compactor 117 containing a pressurized oil container 119 of at least 20 Gallons, a high temperature oil pump 120 and an electric motor 121 and a heat exchanger 122 (not shown). The oil pump recirculates the oil between the pressurized container and the heat exchanger to maintain the oil at a desired temperature. After resin injection in the FIP mold 116, the preheated oil is injected at a given flow rate and temperature to fulfill the impregnation of the fibers and consolidate the composite component. The compactor contains a high frequency valve 123 allowing varying the oil pressure from a nominal value (i.e. 7 Bars) down to zero at a repeated frequency typically between 1 and 50 Hz. This repeated pressure variation generates a dynamic compaction of the fibrous strengthener in the FIP and helps consolidate the composite part. The heat exchanger in the compactor also allows controlling the temperature of the oil during curing the composite component. The recirculating oil in the FIP mold is also used to extract the exothermic heat of the reacting polymer reducing the thermal induced stresses in the molded component. The recirculating oil also facilitates the cooling of the cured component by applying cool water to the heat exchanger in the compactor. The functions in the compactor are automated with an on-board automate unit 124 and data acquisition unit 125.

FIG. 7 shows a typical molding cycle to manufacture a composite component with FIP process and the compactor 117. First, the resin is injected into the FIP mold 116 under pressure. Once the total amount of resin has been injected into the mold assembly, at a time t1, all the injection gates in the FIP mold are clamped, resulting in a pressure loss in the resin inside the mold. The compactor 117 is then activated and heated oil enters the FIP compaction cavity at a time t2 increasing the resin pressure. The compactor apply first a dynamic pressure at a given frequency that variates oil pressure from a nominal value to zero. During the dynamic compaction, resin distribution in the mold occurs quickly until a time t3. Once the resin reaches the vents of the mold, the vents are clampled avoiding any resin discharge. The dynamic compaction is applied for some time after closing the vents, typically between 1 and 10 minutes, to help consolidate the composite component. After a time t4, the compactor is set to a constant pressure to be maintained during the curing cycle of the composite component.

1. A resin delivery unit for composites manufacturing comprising an automated resin degassing and loading station.

2. A resin delivery unit for composites manufacturing comprising an in-line liquid heat exchanger.

3. The resin delivery unit of claim 1, wherein the automated resin degassing and loading station comprise a pressurized container receiving a resin pail, a pneumatic mixer, an electric heating belt, a resin charging/discharging pipe, a vacuum port, a pressure sensor and a series of electrical valves.

4. The resin delivery unit of claim 2, wherein the in-line liquid heat exchanger comprise a reusable or disposable multi-plates heat exchanger connected to the resin injector and to the mold, and heated by an external liquid heating unit.

5. An oil dynamic compactor unit to be used with FIP for composites manufacturing comprising a pressurized oil container of at least 20 Gallons.

6. An oil dynamic compactor unit of claim 5, comprising a high temperature electric oil pump.

7. An oil dynamic compactor unit of claim 5, comprising a heat exchanger to heat-up or cool the circulating oil.

8. An oil dynamic compactor unit of claim 5, comprising a high frequency valve acting between 1 and 50 Hz.

9. A process to mold a composite component by FIP, comprising a dynamic compactor unit of claim 5, wherein dynamic compaction is applied to the composite component after resin injection in the mold cavity.

10. A process to mold a composite component by FIP of claim 9 wherein dynamic compaction has a frequency between 1 and 50 Hz.

11. A process to mold a composite component by FIP of claim 9 wherein dynamic compaction has an amplitude between nominal pressure and zero.

12. A process to mold a composite component by FIP of claim 9 wherein dynamic compaction is applied after closing the mold vents for a time varying between 1 and 10 minutes.
